(19) United States
(12) Patent Application Publication
(10) Pub. No.: US 2024/0045741 A1
(43) Pub. Date: Feb. 8, 2024

(54) METHODS AND SYSTEMS FOR A THREE-TIERED CONTENT NOTIFICATION SYSTEM FOR A DATA EXCHANGE FEATURING NON-HOMOGENOUS DATA TYPES

(71) Applicant: Capital One Services, LLC, McLean, VA (US)

(72) Inventors: Gaurav SINGH, Glen Allen, VA (US); Odean George MAYE, Midlothian, VA (US); Pankaj SINGH, Glen Allen, VA (US); Rangarajan LAKSHMINARAYANACHAR, Glen Allen, VA (US); Sheel KHANNA, Glen Allen, VA (US)

(73) Assignee: Capital One Services, LLC, McLean, VA (US)

(21) Appl. No.: 17/816,939

(22) Filed: Aug. 2, 2022

(51) Int. Cl. G06F 9/54

(52) U.S. Cl. CPC G06F 9/542; G06F 9/546

(57) ABSTRACT

A three-tiered content notification system that trifurcates the content notification system into a message consumption component, a message filtering component, and a message delivery component. The message queue comprises content published to an event application programming interface (“API”) for the content notification system. By generating this queue of available content, the message filtering component may apply a batch filter on the available content as opposed to conventional per item filtering. During batch filtering, filtering criteria may be applied to all content currently in the queue. The system may rank this content such that only the highest priority and/or relevance ranking may remain in the batch. Content that is not filtered out by the system may then be sent to the message delivery component. At the message delivery component, the system may select delivery channels for the remaining content.

### BACKGROUND

As the world increasingly moves towards the use of electronic storage as the predominant storage method, the amount and type of data in storage continues to expand. As such, computing systems increasingly rely on ever-expanding data stores, including cloud-based data stores.

### SUMMARY

As the amount of data stored increases, and the location (and types of locations) of that storage continues to diversify, coordinating data storage becomes increasingly complex. Not only do computing systems need to ensure that data is safely and securely stored, but computing systems also need to maintain efficient access to that data as well as provide navigation and searching functions. To provide these functions, a computing system may implement a data exchange. A data exchange may facilitate the process of sending, storing, and searching data. For example, a data exchange may comprise, or involve the process of, receiving data structured under a source schema and formatting it into a target schema in order to ensure that the target schema is an accurate representation of the source data. Data exchanges may then allow data to be shared between different computer systems and/or programs.

As data from multiple sources and multiple streams converge at a single point, access to this data is improved. That is, the single point of access allows for any system wishing to access any available information in the data exchange to only have to search the single point. Such single point access greatly reduces the complexity of searching and navigating for data as the search and navigation is only required to be done on the single point. However, single point access does have a downside in that all systems and users are now receiving results based on an exponentially larger amount of data. This means that unless the user or requesting system enters a complex search string with numerous filtering criteria and/or categorical exclusions, the results of the search will have many irrelevant results.

To further compound the problems faced by users searching a data exchange, the terminology used by one user may be the same as another user even if the two users have different technical backgrounds and are searching for data serving different functions. For example, one user (e.g., a user with a software background) may enter a first search string relating to “asset integration in intake systems.” In contrast, another user (e.g., a user with a hardware background) may enter the same search strings, but the other user may be looking for a hardware asset as opposed to a software asset. Thus, even if the users enter search strings with numerous filtering criteria and/or categorical exclusions, they may not be able to return only relevant results due to their use of similar terminology. Accordingly, data exchanges face the technical problem of how to limit search results to those that would be relevant to a requestor, particularly in data exchanges featuring non-homogenous data types.

This technical problem is particularly acute in the context of a real-time content notification system for the data exchange. For example, users of the data exchange may wish to receive notifications when content relevant to them is added and/or modified in the data exchange. Conventional approaches to serving this need may include allowing a user to subscribe to a type of content; however, as the amount of content in the data exchange increases and the terminology used to describe that content overlaps in technical, functional, and organizational usage, adequately describing what specific content a user wishes to subscribe to becomes difficult. As users cannot adequately describe what content they wish to receive (or to adequately distinguish that content from other content), conventional content notification systems, which rely on users to do so, default to sending largely irrelevant content notifications. Furthermore, as these notifications are based on static user subscriptions, the relevance of content sent to a user diminishes over time.

In view of this problem, the methods and systems are described herein for a three-tiered content notification system for a data exchange featuring non-homogenous data types. For example, the three-tiered content notification system trifurcates the content notification system into a message consumption component, a message filtering component, and a message delivery component. By trifurcating the content notification system into these components, each component may address technical challenges that lead to the aforementioned technical problem. For example, as opposed to a conventional approach, the message consumption component creates a message queue. The message queue comprises content published to an event application programming interface (“API”) for the content notification system. For example, rather than filtering content when it is published to the API, the system queues this content. By generating this queue of available content, the message filtering component may apply a batch filter on the available content as opposed to conventional per item filtering. During batch filtering, filtering criteria may be applied to all content currently in the queue. The system may rank this content such that only the highest priority and/or relevance ranking may remain in the batch. Content that is not filtered out by the system may then be sent to the message delivery component. At the message delivery component, the system may select delivery channels for the remaining content. For example, by processing the content remaining in the batch using the message delivery component, the system may direct the content remaining in the batch to different delivery channels (e.g., based on the priority and/or relevance ranking). For example, high priority content may be directed to a user via a messenger application (e.g., a text message or instant messaging application), while other content may be transmitted via email and/or other communication means.

As an additional technical benefit of the three-tiered content notification system, the system is more scalable than conventional single tiered approaches. For example, modifications to any one of the components (e.g., increasing a queue size of the message consumption component, revising a filtering algorithm of the message filtering component, and/or adding new delivery channels to the message delivery component) does not affect the other components.

In some aspects, systems and methods for generating content notifications for a data exchange featuring non-homogenous data types are described. For example, the system may receive, at a message consumption component, a first subset of content, wherein the first subset of content comprises content corresponding to a first user content subscription setting for a first user. The system may generate, at a message consumption component, a first queue of content based on a first portion of the first subset of content, wherein the first portion is received during a first time period. The system may simultaneously apply, at a message filtering component, a batch filtering criterion to the first portion to generate a second subset of content. The system may determine, at a message delivery component, for each message in the second subset of content a respective delivery channel of a plurality of delivery channels. The system may generate for display, on a user interface of a user device, each message in the second subset of content using the respective delivery channel.

Various other aspects, features, and advantages of the invention will be apparent through the detailed description of the invention and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative architecture for a three-tiered content notification system for a data exchange featuring non-homogenous data types, in accordance with one or more embodiments.

FIG. 2 shows an illustrative workflow through a three-tiered content notification system for a data exchange featuring non-homogenous data types, in accordance with one or more embodiments.

FIG. 3 depicts an illustrative system for a content notification system for a data exchange, in accordance with an embodiment.

FIG. 4 depicts a process for generating content notifications for a data exchange featuring non-homogenous data types, in accordance with an embodiment.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details, or with an equivalent arrangement. In other cases, well-known structures and devices are shown in block diagram form in order to avoid unnecessarily obscuring the embodiments of the invention.

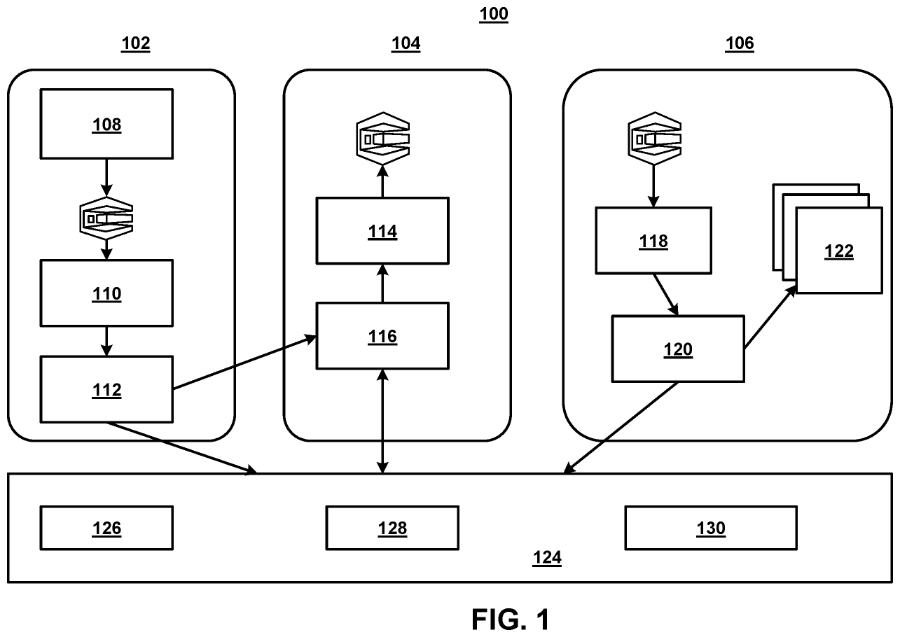

FIG. 1 shows an illustrative architecture for a three-tiered content notification system for a data exchange featuring non-homogenous data types, in accordance with one or more embodiments. For example, architecture 100 may comprise a three-tiered notification system. As shown in FIG. 1, architecture 100 may comprise a three-tiered content notification system for a data exchange featuring non-homogenous data types. For example, architecture 100, which in some embodiments may be cloud-based, may comprise message consumption component 102. For example, message consumption component 102 may comprise a queue of content, corresponding to user content subscription settings, published to an application programming interface (“API”) for the content notification system. Architecture 100 may comprise message filtering component 104. Message filtering component 104 may comprise batch filtering criteria for simultaneously applying to queued content.

As described herein, filtering criteria may comprise any criteria that may be used to distinguish one type of content (or message) from another. In some embodiments, filtering criteria may comprise criteria selected by a user (e.g., based on a user setting) or may comprise a pre-stored setting based on network conditions (e.g., the number of messages in a queue, a time of day, a total size of queue content, etc.).

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be a digital representation of a person's identity.

Architecture 100 may comprise message delivery component 106. Message delivery component may comprise a message delivery component comprising channel delivery criteria, wherein the channel delivery criteria define a delivery channel of a plurality of delivery channels used to transmit filtered content to users.

As referred to herein, a delivery channel may comprise an environment where the audience or consumer of the content will discover and access it. For example, types of delivery channels may include face-to-face conversations, video conferencing, audio conferencing, emails, written letters and memos, chats and messaging, blogs, and formal written documents. Each type of delivery channel may comprise specific settings and/or criteria defining the instances when a given delivery channel should be used.

Architecture 100 may store the components in cloud-based storage and may perform functions related to a three-tiered content notification system for a data exchange featuring non-homogenous data types using cloud-based control circuitry configured and cloud-based input/output circuitry configured to transmit each message in the second subset of content using the respective delivery channel. For example, the cloud-based control circuitry may be configured to receive, at the message consumption component, a first subset of content, wherein the first subset of content comprises content corresponding to a first user content subscription setting for a first user. The system may then generate, at the message consumption component, a first queue of content based on a first portion of the first subset of content, wherein the first portion is received during a first time period. The system may then simultaneously apply, at a message filtering component, a batch filtering criterion to the first portion to generate a second subset of content. The system may determine, at message delivery component, for each message in the second subset of content a respective delivery channel or a plurality of delivery channels.

For example, in architecture 100, queue publisher 108 may publish a message to a queue (e.g., a SQS queue). A queue consumer 110 consumes the message from the queue. Event service 112 may then decrypt and pass a message from a queue. Event service 112 may pass the message to data abstraction layer 124 (e.g., at a database) and/or message filter 116 (e.g., initiating the filtering phase).

Message filtering component 104 may communicate with data abstraction layer 124 to retrieve appropriate topic subscriptions (e.g., from a subscription database 128) and to use subscription-based filtering criteria to create notification messages. If a notification message is created it may be stored in a filtering publisher 114.

Data abstraction layer 124 may comprise event database 126, which may store rules and presets for given events, messages, and/or content type. Additionally, data abstraction layer 124 may comprise message notification database 130, which may provide rules and presets for selection of a delivery channel. At message delivery component 106, queue publisher 118 publishes a message notification to the queue. Delivery service 120 may then select a delivery channel from delivery channel database 122.

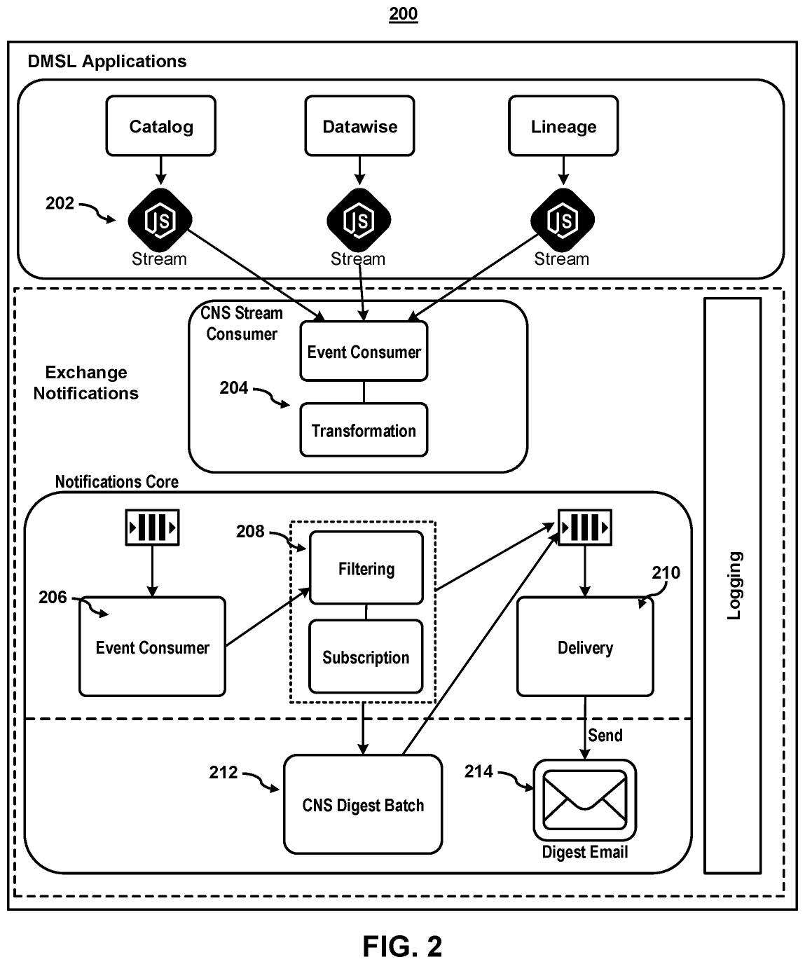

FIG. 2 shows an illustrative workflow through a three-tiered content notification system for a data exchange featuring non-homogenous data types, in accordance with one or more embodiments. For example, at a directory service markup language layer 202, the system may receive a plurality of data streams, each comprising a type of data. As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time series data as a data stream.

At exchange notification layer 204, the data of various types and/or from various data streams may be transformed into the generic event which can be understood by the content notification system's core processes. At event consumer 206, the system may consume messages (e.g., from the data streams) and pass the message to filtering component 208, which may retrieve subscription information and/or filter messages in queued content.

In some embodiments, filtering component 208 may comprise batch filtering processes that are configured to run at specific times and/or intervals (e.g., in order to most efficiently process information). For example, filtering component 208 may be configured to run at a specific time in the night when processing loads are low. In such cases, filtering component 208 may retrieve all the data received from the previous day and filter out the duplicate records. Digest batch 212 may be used to create the event model to publish the message to a delivery channel (e.g., at delivery component 210). Delivery component 210 may then select a delivery channel and transmit a message (e.g., message 214) using the selected delivery channel.

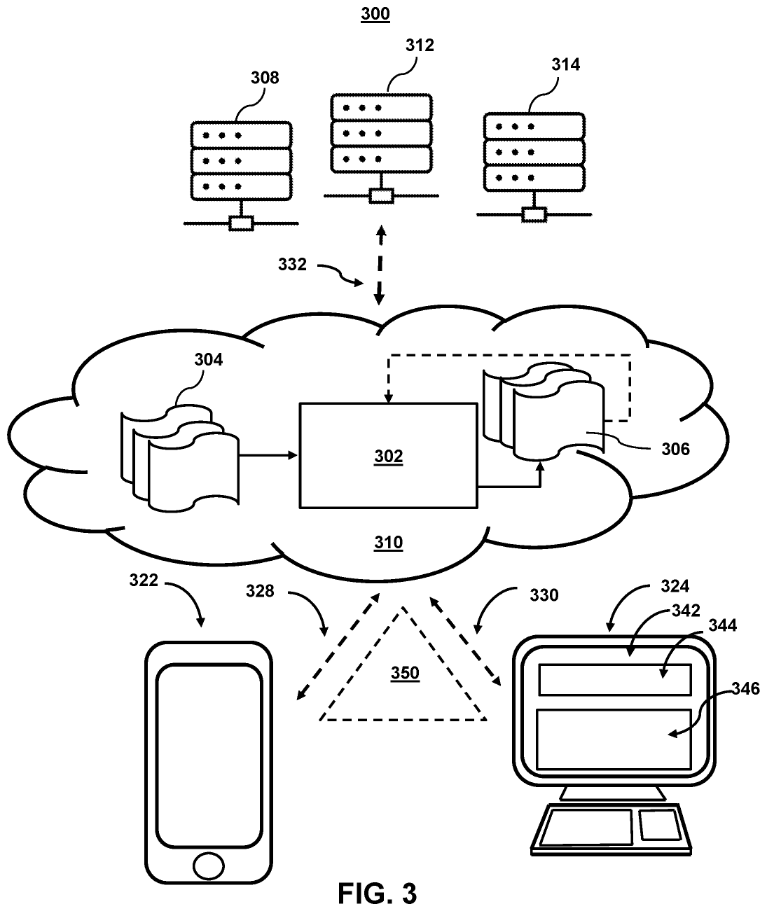

FIG. 3 shows illustrative system components for searching a data exchange for information on assets with non-homogenous functionality and non-standardized data descriptions using credentials corresponding to users conducting searches, in accordance with one or more embodiments. For example, a system may represent the components used for searching a data exchange, as shown in FIG. 1. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted that while one or more operations are described herein as being performed by particular components of system 300, those operations may, in some embodiments, be performed by other components of system 300. As an example, while one or more operations are described herein as being performed by components of mobile device 322, those operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., search inputs, responses, queries, and/or notifications).

Additionally, as mobile device 322 and user terminal 324 are shown as touchscreen smartphones, these displays also act as user input interfaces. It should be noted that in some embodiments, the devices may have neither user input interface nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to searching a data exchange.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may be a database configured to store user data for a user. This user data may be collected in a user data profile for a user. For example, the user profile data may include user data that the system has collected about the user through prior interactions, both actively and passively. For example, the user data may describe one or more characteristics of a user, a user device, one or more search queries input by the user, one or more digital assets owned by or associated with the user, one or more digital assets previously accessed by the user, or other information related to the user's access of the data exchange. Alternatively, or additionally, the system may act as a clearing house for multiple sources of information about the user. This information may be compiled into a user profile. Cloud components 310 may also include control circuitry configured to perform the various operations needed to generate alternative content. For example, the cloud components 310 may include cloud-based storage circuitry configured to generate alternative content. Cloud components 310 may also include cloud-based control circuitry configured to run processes to determine alternative content. Cloud components 310 may also include cloud-based I/O circuitry configured to display alternative content.

Cloud components 310 may include first data source 308, second data source 312 and crowdsourced database 314. First data source 308 may correspond to a data source of a first entity (e.g., a first crowdsourced user). First data source 308 may have a first native data structure and/or first attribute. The first native data structure and/or first attribute may correspond to a software architecture, data flow, threat, and/or mitigation technique corresponding to first contribution. Second data source 312 may correspond to a data source of a second entity (e.g., a second crowdsourced user). Second data source 312 may have a second native data structure and/or second attribute. The second native data structure and/or second attribute may correspond to a software architecture, data flow, threat and/or mitigation technique corresponding to second contribution. Crowdsourced database 314 may correspond to a crowdsourced database housing the data exchange system, which may be distinct from the first and second entity. Crowdsourced database 314 may have a native hierarchical data structure (e.g., a connected graph data exchange database) and/or native attribute. Furthermore, the system may use machine learning to generate a hierarchical data structure for crowdsourced database 314 based on first data source 308 and second data source 312 even though first data source 308 and second data source 312 may feature different attributes. In some embodiments, first data source 308, second data source 312, and crowdsourced database 314 may correspond to data source 202, data source 206, and crowdsourced database 204, respectively.

Cloud components 310 may also include model 302, which may be a connected graph data exchange database (e.g., as described in FIG. 2) and/or AI model, that generates a connected graph data exchange database. Model 302 may take inputs 304 and provide outputs 306. The inputs may include multiple datasets such as a training dataset and a test dataset. Each of the plurality of datasets (e.g., inputs 304) may include data subsets related to hierarchical data structures for the crowdsourced database, attributes, native data, and/or other information. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known data structure. The system may then train the first machine learning model to classify inputted data structures to known data structures of hierarchical data structures (e.g., to determine similarities between different semantic annotations and/or other attributes).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, model 302 may predict one or more attributes and may include a probability that the attributes correspond. Attributes may include one or more words, phrases, values, or other portions of search strings that are used in a search process. For example, the system may determine that particular characteristics are more likely to be indicative of a particular attribute or that one or more attributes correspond. In some embodiments, the model (e.g., model 302) may automatically perform actions (e.g., generate a notification, generate reference data, etc.) based on outputs 306. In some embodiments, the model (e.g., model 302) may not perform any actions. The output of the model (e.g., model 302) may be used to generate for display, on a user interface, a notification related to an attribute, reference data, a custom data structure, etc.

The machine learning model may determine keyword similarities and/or semantic closeness between keywords in the first and second attributes, respectively, or the first and second data structures. For example, the system may retrieve a first attribute keyword for the first data structure and then retrieve a second attribute keyword for the second data structure. For example, the system may identify a keyword of a topic (or category) under which the first data structure indexes and/or organizes in the connected graph data exchange database (e.g., based on a set of relationships between attributes of the user profile data and data exchange assets). Additionally, the system may identify a keyword of a topic (or category) under which the second data structure indexes and/or organizes in the connected graph data exchange database (e.g., based on a set of relationships between attributes of the user profile data and data exchange assets). The system may then determine a first similarity between the first attribute keyword and the second attribute keyword. For example, the system may determine a vector space distance between two textual entities (keywords, hashes, documents, etc.). The system may then compare the first similarity to a threshold similarity. The system may then determine that the first attribute keyword and the second attribute keyword correspond based on the first similarity equaling or exceeding the threshold similarity (and not correspond otherwise). The system may then populate the data exchange contribution and the node of the data exchange system in response to determining that the first attribute keyword and the second attribute keyword correspond.

System 300 also includes API layer 350. API layer 350 may allow the system to generate recommendations across different devices. In some embodiments, API layer 350 may be implemented on user device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

FIG. 3 also shows an illustrative user interface for searching one or more data exchanges, in accordance with one or more embodiments. For example, the system generates user interface 342 in response to a user request to initiate a search of one or more data exchanges, such as a user selecting a search function in a software application, the user accessing a web-page for searching one or more data exchanges, the user requesting a search using a voice command, and other means for requesting search functionality for one or more data exchanges.

As referred to herein, a “user interface” may comprise a human-computer interaction and communication in a device, and may include display screens, keyboards, a mouse, and the appearance of a desktop. For example, a user interface may comprise a way a user interacts with an application or a website. As described herein, the application and/or website may comprise a data exchange system as described herein. The data exchange system may comprise a plurality of data exchange contributions. For example, the system may comprise user profile data comprising a connected graph data exchange database, wherein the connected graph data exchange database comprises a graph-based hierarchy of data exchange contributions for the user profile data, and wherein the graph-based hierarchy of data exchange contributions comprises data exchange contributions from a plurality of sources. For example, the plurality of sources may comprise different authors, organizations, and/or other entities.

User interface 342 may allow users to enter information about a data exchange system and/or data exchange contribution (e.g., via icon 344). For example, a data exchange contribution may include any data or content added to and/or accessed by the data exchange. A data exchange contribution may include an attribute. An attribute may include any information that describes the contribution, such as a topic or category of the contribution, including information used to populate an attribute for the contribution and/or otherwise describe a data structure and/or model structure for a data exchange contribution. For example, the attribute may indicate how a contribution is indexed and/or archived in a connected graph data exchange database and/or data exchange system. For example, each data exchange contribution may correspond to content and/or an attribute. For example, the attribute may provide an attribute that provides a fully semantic data model used to enable data entered into the system to be meaningfully applied across different data exchange application domain contexts (e.g., provide connections between different nodes of the connected graph data exchange database). In some embodiments, the system may include a custom attribute, which may be an attribute of a custom data structure. The custom attribute may comprise reference data as described herein.

The data exchange system may arrange and/or organize the data exchange contributions into a graph-based hierarchy. For example, the system may organize the various data exchange contributions into a system in which data exchange contributions are organized one above the other according to function. The hierarchy may comprise a plurality of data exchange contributions arranged in series and/or in parallel in which the inputs and outputs are intertwined such that information from one or more data exchange contributions may be received from, and/or used by, one or more other data exchange contributions.

Each data exchange contribution may comprise content such as software applications, instructions, and/or other information used by a data exchange system. Each data exchange may also include an attribute and/or other characteristics about a contribution that describes the data exchange contributions and/or portions of the data exchange contributions. In some embodiments, the attribute may include information populated in a data structure and/or model structure as described herein, as well as the input and/or outputs that are processed by a data exchange system and/or one or more data exchange contributions. For example, the attribute may represent a fully semantic data model used to enable data entered into the system to be meaningfully applied across different data exchange application domain contexts.

In some embodiments, the system may use the content such as contribution attributes (e.g., ontologies and/or values associated with a category of an attribute) to organize data exchange contributions into the hierarchy. The hierarchy may comprise a connected graph data exchange database as described herein. The data exchange may comprise a complex structured and/or unstructured set of information used by a computer system to enable a data exchange system. While embodiments are described herein with respect to a connected graph data exchange database, these embodiments may alternatively or additionally use a hierarchical or relational database structure to link different content (e.g., data exchange contributions) within the data exchange system. For example, a hierarchical database structure may be a structure in which data is organized into a tree-like structure. For example, the data may be stored as records which are connected to one another through links. A record may be a collection of fields, with each field containing only one value (e.g., content). The type of a record may define which fields the record contains. In some embodiments, the tree structure may comprise a node-link structure in which a parent node links to child nodes, nested sets (e.g., in relational databases), radial trees, and/or other organizational systems.

Each data exchange contribution may comprise a component of the data exchange. For example, “components” of a data exchange may include portions of the data exchange (e.g., corresponding to one or more nodes of the connected graph data exchange database) that provide modeling for a specific domain application, address specific contributions, provide a specific function, and/or are otherwise distinct from other portions of the data exchange.

When the system receives a user request to access user interface 100, the system accesses the user's credentials from a profile associated with the user. For example, when the system receives a request from the user to access user interface 100, the system accesses the profile of the user stored in a data storage location to obtain credentials associated with the user. Credentials associated with the user may include a user name, a user role, a user business unit, a list of user team memberships, a user organization, a search history associated with the user, and other similar credentials.

User interface 342 includes input icon 444 and search results 346. In some embodiments, user interface 342 may also include other user interface elements, such as additional text boxes, additional fields, additional input mechanisms, and other elements. Input icon 344 receives input from a user, and the system receives the input. The system may then use the received input as a search string. The system may receive a manual user input to input icon 344, for example, by receiving a manual input from a user using a mouse and keyboard to select text inputs and enter a text string. In other embodiments, the system can populate text automatically, such as populating text with a search string in response to a user selecting a specific hyperlink or user interface element, in response to receiving a voice command from the user, or in response to receiving another form of automatic input to text.

Content 346 may display returned search results. For example, the system may perform a search and receive, from the data exchange, a list of search results matching the search string. The system may then provide the list of search results to the content 346 for display. In some embodiments, content 346 may display the most relevant search results at the top of a list of returned search results. In some embodiments, the system may receive a selection of one or more displayed search results (e.g., may receive a manual selection in response to a user clicking on one of the displayed search results). In response to receiving the selection of the one or more displayed search results, the system may provide additional details about the selected one or more displayed search results, such as asset owner, one or more pieces of asset functionality, asset data, asset type, and other additional details, to content 346 for display.

In some embodiments, content 346 may comprise a notification and/or a recommendation. For example, the system may provide numerous types of notifications and/or recommendations as described herein. In some embodiments, user interface 342 (or the recommendation data therein) may be presented as a status page. The status page may include summary information about a data exchange system, data exchange contribution, comparison data, reference data, and recommendation data as well as issues, stakeholders, responsible contributors, etc. The status page may also include queries that may be performed.

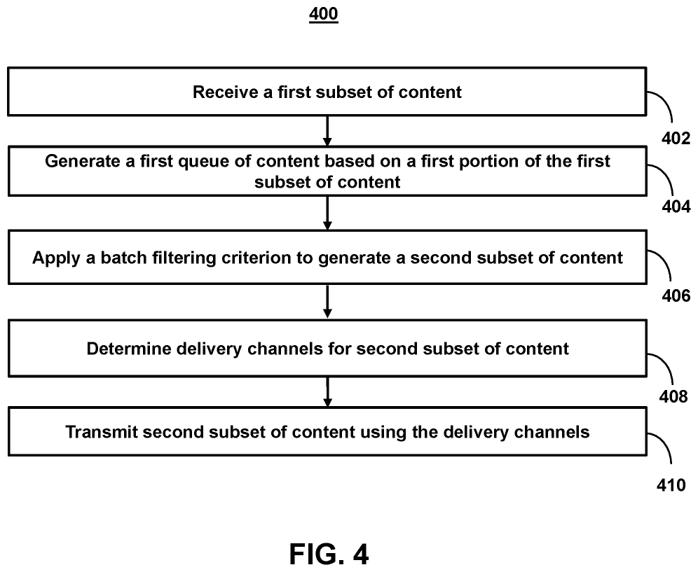

FIG. 4 depicts a process for generating content notifications for a data exchange featuring non-homogenous data types. For example, FIG. 4 shows process 400, which may be implemented by one or more devices. The system may implement process 400 in order to generate one or more notifications on user interfaces (e.g., as described in FIG. 3).

At step 402, process 400 receives (e.g., using control circuitry of one or more components of system 300 (FIG. 3)) a first subset of content. For example, the system may receive, at a message consumption component, a first subset of content, wherein the first subset of content comprises content corresponding to a first user content subscription setting for a first user. For example, the system may receive an initial set of content that has been published to the data exchange that corresponds to one or more user subscriptions or settings for a user.

For example, the system may perform some initial filtering to content published to the data exchange to generate a subset of content for the user. In some embodiments, the system may receive, at the message consumption component, a plurality of content published to an application programming interface (“API”) for the content notification system. The system may then filter the plurality of content using the first user content subscription setting to generate the first subset of content.

At step 404, process 400 generates (e.g., using control circuitry of one or more components of system 300 (FIG. 3)) a first queue of content based on a first portion of the first subset of content. For example, the system may generate, at a message consumption component, a first queue of content based on a first portion of the first subset of content, wherein the first portion is received during a first time period. For example, as opposed to a conventional approach, the message consumption component creates a message queue. The message queue comprises content published to an event application programming interface (“API”) for the content notification system. For example, as opposed to filtering as content is published to the API, the system queues this content.

The system may retrieve messages out of the queue on a periodic and/or continuous schedule. For example, the system may first retrieve the first portion of the first subset and then retrieve a second portion. For example, the system may generate, at the message consumption component, a second queue of content based on a second portion of the first subset of content, wherein the second portion is received during a second time period. The system may simultaneously apply the batch filtering criterion to the portion of the second subset of content to generate a second subset of content.

At step 406, process 400 applies (e.g., using control circuitry of one or more components of system 300 (FIG. 3)) a batch filtering criterion to generate a second subset of content. For example, the system may simultaneously apply, at a message filtering component, a batch filtering criterion to the first portion to generate a second subset of content. For example, by generating this queue of available content, the message filtering component may apply a batch filter on the available content as opposed to conventional per item filtering.

In some embodiments, simultaneously applying the batch filtering criterion to the first portion to generate the second subset of content may comprise the system assigning a relevance ranking to each message in the subset. For example, the system may determine, based on the batch filtering criterion, a respective relevance ranking for each message in the portion of the first subset of content. The system may compare the respective relevance ranking for each message in the portion of the first subset of content to a threshold relevance ranking. The system may add each message in the portion of the first subset of content to the second subset of content in response to determining that the respective relevance ranking exceeds the threshold relevance ranking.

In some embodiments, the system may process messages using a specific filtering algorithm. For example, the system may select an algorithm that is more computational efficient during times of heavy processing loads. In such cases, the system may simultaneously apply the batch filtering criterion to the first portion by retrieving each message in the second subset of content and processing each message using a first filtering algorithm of a plurality of filtering algorithms. For example, the system may determine a rate at which the first queue is filled. The system may then select the first filtering algorithm of the plurality of filtering algorithms based on the rate.

For example, to generate the second subset of content, the system may apply various criteria and/or rankings to messages in the first subset of content. For example, the system may retrieve portions of the messages in the first subset of content based on time of receipt, total size of the queue, number of messages in the queue, etc. For example, the system may determine a number of messages in the first subset of content. The system may determine the threshold relevance ranking based on the number of messages. In another example, the system may determine a user setting. The system may determine the threshold relevance ranking based on the user setting.

The relevance ranking and/or priority may be based on one or more factors. For example, the system may determine a number of messages in the second subset of content. The system may determine the respective threshold relevance ranking for each delivery channel of the plurality of delivery channels based on the number of messages in the second subset of content.

At step 408, process 400 determines (e.g., using control circuitry of one or more components of system 300 (FIG. 3)) a delivery channel for a second subset of content. For example, the system may determine, at a message delivery component, for each message in the second subset of content a respective delivery channel of a plurality of delivery channels.

For example, determining for each message in the second subset of content the respective delivery channel may comprise determining, based on the batch filtering criterion, a respective relevance ranking for each message in the second subset of content and comparing the respective relevance ranking for each message in second subset of content to a respective threshold relevance ranking for each delivery channel of the plurality of delivery channels. For example, the system may then use the relevance ranking and/or priority to determine a delivery channel for each message.

At step 410, process 400 transmits (e.g., using control circuitry of one or more components of system 300 (FIG. 3)) a second subset of content using the delivery channels. For example, the system may generate for display, on a user interface of a user device, each message in the second subset of content using the respective delivery channel.

It is contemplated that the steps or descriptions of FIG. 4 may be used with any other embodiment of this disclosure. In addition, the steps and descriptions described in relation to FIG. 4 may be done in alternative orders, or in parallel to further the purposes of this disclosure. For example, each of these steps may be performed in any order, in parallel, or simultaneously to reduce lag or increase the speed of the system or method. Furthermore, it should be noted that any of the devices or equipment discussed in relation to FIGS. 1-3 could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: receiving, at a message consumption component, a first subset of content, wherein the first subset of content comprises content corresponding to a first user content subscription setting for a first user; generating, at a message consumption component, a first queue of content based on a first portion of the first subset of content, wherein the first portion is received during a first time period; simultaneously applying, at a message filtering component, a batch filtering criterion to the first portion to generate a second subset of content; determining, at a message delivery component, for each message in the second subset of content a respective delivery channel of a plurality of delivery channels; and generating for display, on a user interface of a user device, each message in the second subset of content using the respective delivery channel.
2. A method of the preceding embodiment, wherein the method is for generating content notifications for a data exchange featuring non-homogenous data types.
3. The method of any one of the preceding embodiments, further comprising: receiving, at the message consumption component, a plurality of content published to an application programming interface (“API”) for the content notification system; and filtering the plurality of content using the first user content subscription setting to generate the first subset of content.
4. The method of any one of the preceding embodiments, wherein determining for each message in the second subset of content the respective delivery channel further comprises: determining, based on the batch filtering criterion, a respective relevance ranking for each message in the second subset of content; and comparing the respective relevance ranking for each message in second subset of content to a respective threshold relevance ranking for each delivery channel of the plurality of delivery channels.
5. The method of any one of the preceding embodiments, further comprising: determining a number of messages in the second subset of content; and determining the respective threshold relevance ranking for each delivery channel of the plurality of delivery channels based on the number of messages in the second subset of content.
6. The method of any one of the preceding embodiments, wherein simultaneously applying the batch filtering criterion to the first portion to generate the second subset of content further comprises: determining, based on the batch filtering criterion, a respective relevance ranking for each message in the portion of the first subset of content; comparing the respective relevance ranking for each message in the portion of the first subset of content to a threshold relevance ranking; and adding each message in the portion of the first subset of content to the second subset of content in response to determining that the respective relevance ranking exceeds the threshold relevance ranking.
7. The method of any one of the preceding embodiments, further comprising: determining a number of messages in the first subset of content; and determining the threshold relevance ranking based on the number of messages.
8. The method of any one of the preceding embodiments, further comprising: determining a user setting; and determining the threshold relevance ranking based on the user setting.
9. The method of any one of the preceding embodiments, further comprising: generating, at the message consumption component, a second queue of content based on a second portion of the first subset of content, wherein the second portion is received during a second time period; and simultaneously applying the batch filtering criterion to the portion of the second subset of content to generate a second subset of content.
10. The method of any one of the preceding embodiments, wherein simultaneously applying the batch filtering criterion to the first portion further comprises: retrieving each message in the second subset of content; and processing each message using a first filtering algorithm of a plurality of filtering algorithms.
11. The method of any one of the preceding embodiments, further comprising: determining a rate at which the first queue is filled; and selecting the first filtering algorithm of the plurality of filtering algorithms based on the rate.
12. A tangible, non-transitory, machine-readable medium storing instructions that, when executed by a data processing apparatus, cause the data processing apparatus to perform operations comprising those of any of embodiments 1-11.
13. A system comprising one or more processors; and memory storing instructions that, when executed by the processors, cause the processors to effectuate operations comprising those of any of embodiments 1-11.
14. A system comprising means for performing any of embodiments 1-11.

What is claimed is:

1. A three-tiered content notification system for a data exchange featuring non-homogenous data types, the system comprising:
a message consumption component comprising a queue of content, corresponding to user content subscription settings, published to an application programming interface (“API”) for the content notification system;
a message filtering component comprising batch filtering criteria for simultaneously applying to queued content;
a message delivery component comprising channel delivery criteria, wherein the channel delivery criteria define a delivery channel of a plurality of delivery channels to use to transmitted filtered content to users;
cloud-based control circuitry configured to:
receive, at the message consumption component, a first subset of content, wherein the first subset of content comprises content corresponding to a first user content subscription setting for a first user;
generate, at the message consumption component, a first queue of content based on a first portion of the first subset of content, wherein the first portion is received during a first time period;
simultaneously apply, at a message filtering component, a batch filtering criterion to the first portion to generate a second subset of content; and
determine, at message delivery component, for each message in the second subset of content a respective delivery channel of a plurality of delivery channels; and
cloud-based input/output circuitry configured to transmit each message in the second subset of content using the respective delivery channel.

2. A method for generating content notifications for a data exchange featuring non-homogenous data types, the method comprising:
receiving, at a message consumption component, a first subset of content, wherein the first subset of content comprises content corresponding to a first user content subscription setting for a first user;
generating, at a message consumption component, a first queue of content based on a first portion of the first subset of content, wherein the first portion is received during a first time period;
simultaneously applying, at the message filtering component, a batch filtering criterion to the first portion to generate a second subset of content;
determining, at a message delivery component, for each message in the second subset of content a respective delivery channel of a plurality of delivery channels; and
generating for display on a user interface of a user device, each message in the second subset of content using the respective delivery channel.

3. The method of claim 2, further comprising:
receiving, at the message consumption component, a plurality of content published to an application programming interface (“API”) for the content notification system; and
filtering, at the message filtering component, the plurality of content using the first user content subscription setting to generate the first subset of content.

4. The method of claim 2, wherein determining for each message in the second subset of content the respective delivery channel further comprises:
determining, based on the batch filtering criterion, a respective relevance ranking for each message in the second subset of content; and
comparing the respective relevance ranking for each message in the second subset of content to a respective threshold relevance ranking for each delivery channel of the plurality of delivery channels.

5. The method of claim 4, further comprising:
determining a number of messages in the second subset of content; and
determining the respective threshold relevance ranking for each delivery channel of the plurality of delivery channels based on the number of messages in the second subset of content.

6. The method of claim 2, wherein simultaneously applying the batch filtering criterion to the first portion to generate the second subset of content further comprises:
determining, based on the batch filtering criterion, a respective relevance ranking for each message in the portion of the first subset of content;
comparing the respective relevance ranking for each message in the portion of the first subset of content to a threshold relevance ranking; and
adding each message in the portion of the first subset of content to the second subset of content in response to determining that the respective relevance ranking exceeds the threshold relevance ranking.

7. The method of claim 6, further comprising:
determining a number of messages in the first subset of content; and
determining the threshold relevance ranking based on the number of messages.

8. The method of claim 6, further comprising:
determining a user setting; and
determining the threshold relevance ranking based on the user setting.

9. The method of claim 2 further comprising:
generating, at the message consumption component, a second queue of content based on a second portion of the first subset of content, wherein the second portion is received during a second time period; and
simultaneously applying the batch filtering criterion to the portion of the second subset of content to generate a second subset of content.

10. The method of claim 2, wherein simultaneously applying the batch filtering criterion to the first portion further comprises:
retrieving each message in the second subset of content; and
processing each message using a first filtering algorithm of a plurality of filtering algorithms.

11. The method of claim 10, further comprising:
determining a rate at which the first queue is filled; and
selecting the first filtering algorithm of the plurality of filtering algorithms based on the rate.

12. A non-transitory, computer-readable medium comprising instructions that, when executed by one or more processors, cause operations comprising:
receiving, at a message consumption component, a first subset of content, wherein the first subset of content comprises content corresponding to a first user content subscription setting for a first user;
generating, at the message consumption component, a first queue of content based on a first portion of the first subset of content, wherein the first portion is received during a first time period;
simultaneously applying, at a message filtering component, a batch filtering criterion to the first portion to generate a second subset of content;
determining, at a message delivery component, for each message in the second subset of content a respective delivery channel of a plurality of delivery channels; and
generating for display, on a user interface of a user device, each message in the second subset of content using the respective delivery channel.

13. The non-transitory, computer-readable medium of claim 12, wherein the instructions further cause operations comprising:
receiving, at the message consumption component, a plurality of content published to an application programming interface (“API”) for the content notification system; and
filtering, at the message filtering component, the plurality of content using the first user content subscription setting to generate the first subset of content.

14. The non-transitory, computer-readable medium of claim 12, wherein determining for each message in the second subset of content the respective delivery channel further comprises:
determining, based on the batch filtering criterion, a respective relevance ranking for each message in the second subset of content; and
comparing the respective relevance ranking for each message in the second subset of content to a respective threshold relevance ranking for each delivery channel of the plurality of delivery channels.

15. The non-transitory, computer-readable medium of claim 14, wherein the instructions further cause operations comprising:
determining a number of messages in the second subset of content; and
determining the respective threshold relevance ranking for each delivery channel of the plurality of delivery channels based on the number of messages in the second subset of content.

16. The non-transitory, computer-readable medium of claim 12, wherein simultaneously applying the batch filtering criterion to the first portion to generate the second subset of content further comprising:
determining, based on the batch filtering criterion, a respective relevance ranking for each message in the portion of the first subset of content;
comparing the respective relevance ranking for each message in the portion of the first subset of content to a threshold relevance ranking; and
adding each message in the portion of the first subset of content to the second subset of content in response to determining that the respective relevance ranking exceeds the threshold relevance ranking.

17. The non-transitory, computer-readable medium of claim 16, wherein the instructions further cause operations comprising:
determining a number of messages in the first subset of content; and
determining the threshold relevance ranking based on the number of messages.

18. The non-transitory, computer-readable medium of claim 16, wherein the instructions further cause operations comprising:
determining a user setting; and
determining the threshold relevance ranking based on the user setting.

19. The non-transitory, computer-readable medium of claim 12, wherein the instructions further cause operations comprising:
generating, at the message consumption component, a second queue of content based on a second portion of the first subset of content, wherein the second portion is received during a second time period;
simultaneously applying the batch filtering criterion to the portion of the second subset of content to generate a second subset of content.

20. The non-transitory, computer-readable medium of claim 12, wherein the instructions further cause operations comprising:
determining a rate at which the first queue is filled; and
selecting a first filtering algorithm of the plurality of filtering algorithms based on the rate; and
processing each message using the first filtering algorithm.
